(19) United States
(12) Patent Application Publication
(10) Pub. No.: US 2025/0260827 A1
(43) Pub. Date: Aug. 14, 2025

(54) TECHNIQUES FOR DETERMINING QUALITY OF VIDEOS WITH SYNTHESIZED FILM GRAIN

(71) Applicant: NETFLIX, INC., Los Gatos, CA (US)

(72) Inventors: Andrey NORKIN, Campbell, CA (US); Christos G. BAMPIS, Los Gatos, CA (US); Li-Heng CHEN, Campbell, CA (US); Lukas KRASULA, Campbell, CA (US)

(21) Appl. No.: 19/041,884

(22) Filed: Jan. 30, 2025

Related U.S. Application Data
(60) Provisional application No. 63/552,603, filed on Feb. 12, 2024.

(51) Int. Cl. H04N 19/154; G06T 5/70; H04N 19/59; H04N 19/85

(52) U.S. Cl. CPC H04N 19/154; G06T 5/70; H04N 19/59; H04N 19/85

(57) ABSTRACT

One embodiment of a method for determining video quality includes generating a first comparison video based on a source video, encoding a downscaled and denoised version of the source video to generate an encoded video, decoding the encoded video to generate a decoded video, generating a second comparison video based on the decoded video, and computing a video quality score based on the first comparison video and the second comparison video, where the encoded video is selected for transmission to a client device based on the video quality score.

### CROSS-REFERENCE TO RELATED APPLICATIONS

This application claims the benefit of the United States Provisional Patent Application titled “TECHNIQUES FOR DETERMINING VIDEO QUALITY FOR FILM GRAIN SYNTHESIS,” filed on Feb. 12, 2024, and having Serial No. U.S. 63/552,603. The subject matter of this related application is hereby incorporated herein by reference.

### BACKGROUND

### Field of the Invention

Embodiments of the present disclosure relate generally to media streaming, video encoding, and computer science, more specifically, to techniques for determining the quality of videos with synthesized film grain.

### Description of the Related Art

Film grain is a random optical effect originally attributable to the presence of small particles of metallic silver or dye clouds found on processed photographic film. During playback of video content that includes film grain, the film grain appears as imperfections that provide a distinctive “movie” look to the video content that is aesthetically valued by many producers and viewers. By contrast, during playback of video content that does not include film grain, the lack of those film grain “imperfections” can make the video content appear artificial.

One approach for providing the aesthetically pleasing movie look that includes film grain is to model the film grain and then apply the modeled film grain to decoded video content prior to playback. The modeling can use a number of parameters, referred to herein as “film grain parameters,” that define various properties of the film grain. The film grain parameters can then be transmitted, along with encoded video content, to one or more client devices. In addition, when the video content is encoded at multiple resolutions that the client devices can select for playback, different film grain parameters can be transmitted for each of those resolutions. Each client device can implement a reconstruction application that synthesizes the film grain for a display resolution based on the film grain parameters associated with that resolution. The reconstruction application combines the synthesized film grain with decoded video content that is scaled to the display resolution to generate reconstructed video content that can be played back via a display device.

One drawback of the above approach is that the quality of the reconstructed video content relative to the original video content cannot be accurately determined using conventional video quality metrics. For example, consider a video quality metric, such as the video multimethod assessment fusion (VMAF) technique, that computes the quality of the reconstructed video content based on differences in pixel values between the reconstructed video content and the original video content. Such a video quality metric can assign an incorrectly low quality score to reconstructed video content that includes synthesized film grain appearing in different locations from where film grain appears in the original video content, even when the reconstructed video content is visually similar to the original video content. Notably, these types of incorrectly low quality scores can negatively impact different aspects of a streaming service that requires accurate video quality scores.

One negative impact can arise in the creation of bitrate ladders used for selecting which encoded video streams should be transmitted to various endpoint devices during streaming sessions. A given bitrate ladder is a set of videos that are encoded at different bitrates and resolutions and, therefore, have different video qualities. The bitrate ladder allows a server to dynamically adjust the quality of video content being delivered to a client device based on network conditions and capabilities of the client device, in order to ensure the smooth playback of video content on the client device. However, the bitrates and resolutions in a given bitrate ladder cannot be correctly optimized when the quality of reconstructed video content generated using that bitrate ladder cannot be determined accurately.

Another negative impact can arise in the operation of the servers that deliver streaming content. These types of servers oftentimes select video content to deliver to client devices based on available network bandwidth. When the available network bandwidth is constrained, a given server is supposed to deliver lower quality video content to a client device in order to avoid buffer underrun. Conversely, when the available network bandwidth is less constrained, a given server is supposed to deliver higher quality video to improve the overall video quality during playback. However, when the quality of reconstructed video content cannot be determined accurately, a given server can end up delivering video content having the incorrect quality level to a client device based on a given available network bandwidth.

As the foregoing illustrates, what is needed in the art are more effective techniques for determining the quality of videos with synthesized film grain.

### SUMMARY OF THE EMBODIMENTS

One embodiment of the present disclosure sets forth a computer-implemented method for determining video quality for streaming media implementations. The method includes generating an encoded video based on a source video. The method also includes decoding the encoded video to generate a decoded video. The method further includes generating a comparison video based on the decoded video. In addition, the method includes computing a video quality score based on the source video and the comparison video, where the encoded video is selected for transmission to a client device based on the video quality score.

Another embodiment of the present disclosure sets forth a computer-implemented method for determining video quality for streaming media implementations. The method includes generating a first comparison video based on a source video. The method also includes generating an encoded video based on the source video, and decoding the encoded video to generate a decoded video. The method further includes generating a second comparison video based on the decoded video. In addition, the method includes computing a video quality score based on the first comparison video and the second comparison video, where the encoded video is selected for transmission to a client device based on the video quality score.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques enable the quality of reconstructed video content that includes synthesized film grain to be more accurately determined relative to what can be achieved using prior art techniques. Accordingly, the more accurate determinations of video quality that can be obtained via the disclosed techniques can then be used to generate more optimized bitrate ladders for video streaming and to help ensure that video content of more appropriate quality levels for given levels of available network bandwidth can be transmitted to endpoint devices during streaming sessions. These technical advantages represent one or more technological improvements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a computing system configured to implement one or more aspects of various embodiments;

FIG. 2 is a more detailed illustration of the video analyzer of FIG. 1, according to various embodiments;

FIG. 3 is a flow diagram of method steps for determining the quality of a video with synthesized film grain, according to various embodiments;

FIG. 4 is a flow diagram of method steps for generating comparison videos, according to various embodiments;

FIG. 5 is a flow diagram of method steps for generating comparison videos, according to various other embodiments;

FIG. 6 is a flow diagram of method steps for generating comparison videos, according to various other embodiments;

FIG. 7 is a flow diagram of method steps for generating comparison videos, according to various other embodiments;

FIG. 8 is a flow diagram of method steps for generating comparison videos, according to various other embodiments;

FIG. 9 is a flow diagram of method steps for generating comparison videos, according to various other embodiments;

FIG. 10 illustrates a network infrastructure used to distribute content to content servers and endpoint devices, according to various embodiments of the invention;

FIG. 11 is a block diagram of a content server that may be implemented in conjunction with the network infrastructure of FIG. 10, according to various embodiments of the present invention;

FIG. 12 is a block diagram of a control server that may be implemented in conjunction with the network infrastructure of FIG. 10, according to various embodiments of the present invention; and

FIG. 13 is a block diagram of an endpoint device that may be implemented in conjunction with the network infrastructure of FIG. 10, according to various embodiments of the present invention.

### DETAILED DESCRIPTION

As described, the quality of reconstructed video content that includes synthesized film grain cannot be accurately determined using conventional video quality metrics. In that regard, video quality metrics, such as the video multimethod assessment fusion (VMAF) technique, can assign an incorrectly low quality score to reconstructed video content that includes synthesized film grain appearing in different locations from where film grain appears in original video content, even when the reconstructed video content is visually similar to the original video content. Notably, these types of incorrectly low quality scores can negatively impact different aspects of a streaming service that requires accurate video quality scores, such as the creation of bitrate ladders and the delivery of streaming content.

The disclosed techniques permit the quality of videos with synthesized film grain to be determined. A video analyzer computes one or more quality metrics, which are indicative of the quality of a video with synthesized film grain, using (1) a first comparison video that is either a source video or is generated from a source video, and (2) a second comparison video that is generated from a decoded video that is a decoding of an encoded version of the source video. In some embodiments, the video analyzer can compute a quality metric that compares (1) a first comparison video that is a denoised version of the source video, and (2) a second comparison video that is an upscaled version of the decoded video. In some embodiments, the video analyzer can compute a quality metric that compares (1) a first comparison video that is generated by applying film grain synthesis to a denoised version of the source video, and (2) a second comparison video that is an upscaled version of the decoded video, to which film grain synthesis has been applied, such that the denoised version of the source video to which synthesized film grain was applied and the upscaled version of the decoded video include the same synthesized film grain. In some embodiments, the video analyzer can compute a quality metric that compares (1) a first comparison video that is generated by applying film grain synthesis, obtained from an encoding resolution and scaled to a source video resolution, to a denoised version of a source video; and (2) a second comparison video that is an upscaled version of the decoded video, to which film grain synthesis has been applied, such that the denoised version of the source video to which synthesized film grain was applied and the upscaled version of the decoded video include the same synthesized film grain. In some embodiments, the video analyzer can compute a quality metric that compares (1) a first comparison video that is the source video; and (2) a second comparison video that is generated by extracting noise from the source video, downscaling the source video noise, adding the downscaled source video noise to the decoded video to generate a renoised video, and upscaling the renoised video. In some embodiments, the video analyzer can compute a quality metric that compares (1) a first comparison video that is the source video; and (2) a second comparison video that is generated by extracting noise from a downscaled source video as a difference between the downscaled source video and a denoised downscaled source video, and adding the downscaled source video noise to the decoded video to generate a renoised video. In some embodiments, the video analyzer can compute a quality metric that compares (1) a first comparison video that is the source video; and (2) a second comparison video that is generated by extracting noise from a downscaled source video as a difference between the downscaled source video and a downscaled denoised source video, and adding the downscaled source video noise to the decoded video to generate a renoised video. After computing the quality metric(s), the video analyzer and/or other application(s) can use the quality metric(s) to generate a bitrate ladder, to determine whether to stream a corresponding, and/or in another suitable manner.

At least one technical advantage of the disclosed techniques relative to the prior art is that the disclosed techniques enable the quality of reconstructed video content that includes synthesized film grain to be more accurately determined relative to what can be achieved using prior art techniques. Accordingly, the more accurate determinations of video quality that can be obtained via the disclosed techniques can then be used to generate more optimized bitrate ladders for video streaming and to help ensure that video content of more appropriate quality levels for given levels of available network bandwidth can be transmitted to endpoint devices during streaming sessions.

### System Overview

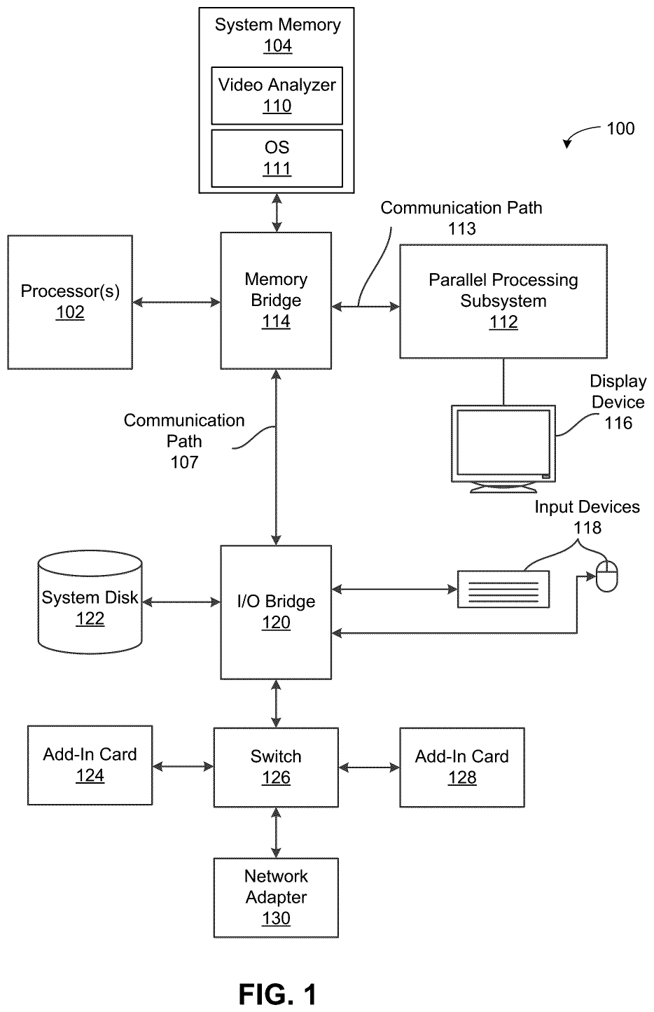

FIG. 1 illustrates a computing system 100 configured to implement one or more aspects of various embodiments. The computing system 100 can be any type of computing device, including, without limitation, a server machine, a server platform, a desktop machine, a laptop machine, a hand-held/mobile device, a digital kiosk, an in-vehicle infotainment system, and/or a wearable device. In some embodiments, the computing system 100 is a server machine operating in a data center or a cloud computing environment that provides scalable computing resources as a service over a network.

As shown, the computing system 100 includes, without limitation, processor(s) 102 and system memory (ies) 104 coupled to a parallel processing subsystem 112 via a memory bridge 114 and a communication path 113. The memory bridge 114 is further coupled to an I/O (input/output) bridge 120 via a communication path 107, and the I/O bridge 120 is, in turn, coupled to a switch 126.

In various embodiments, the I/O bridge 120 is configured to receive user input information from optional input devices 118, such as a keyboard, mouse, touch screen, sensor data analysis (e.g., evaluating gestures, speech, or other information about one or more uses in a field of view or sensory field of one or more sensors), and/or the like, and forward the input information to the processor(s) 102 for processing. In some embodiments, the computing system 100 may be a server machine in a cloud computing environment. In such embodiments, the computing system 100 may not include the input devices 118, but may receive equivalent input information by receiving commands (e.g., responsive to one or more inputs from a remote computing device) in the form of messages transmitted over a network and received via the network adapter 130. In some embodiments, the switch 126 is configured to provide connections between the I/O bridge 120 and other components of the computing system 100, such as a network adapter 130 and various add-in cards 124 and 128.

In some embodiments, the I/O bridge 120 is coupled to a system disk 122 that may be configured to store content and applications and data for use by the processor(s) 102 and the parallel processing subsystem 112. In one some embodiments, the system disk 122 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 120 as well.

In various embodiments, the memory bridge 114 may be a Northbridge chip, and the I/O bridge 120 may be a Southbridge chip. In addition, communication paths 107 and 113, as well as other communication paths within the computing system 100, may be implemented using any technically suitable protocols, including, without limitation, AGP (Accelerated Graphics Port), HyperTransport, or any other bus or point-to-point communication protocol known in the art.

In some embodiments, the parallel processing subsystem 112 comprises a graphics subsystem that delivers pixels to an optional display device 116 that may be any conventional cathode ray tube, liquid crystal display, light-emitting diode display, and/or the like. In such embodiments, the parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

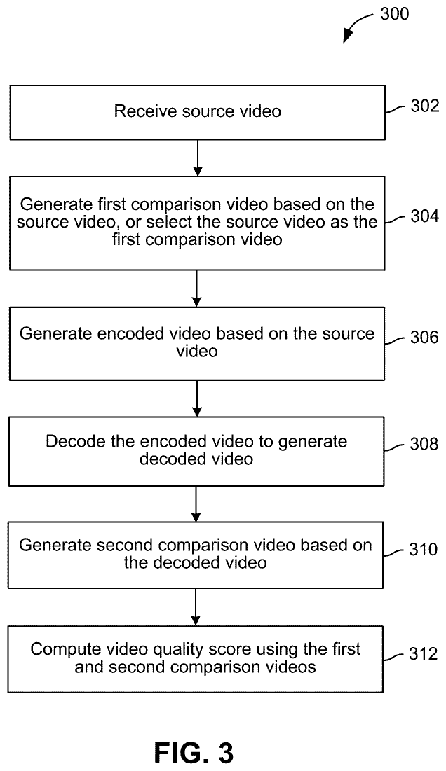

In some embodiments, the parallel processing subsystem 112 incorporates circuitry optimized (e.g., that undergoes optimization) for general purpose and/or compute processing. Again, such circuitry may be incorporated across one or more PPUs included within the parallel processing subsystem 112 that are configured to perform such general purpose and/or compute operations. In yet other embodiments, the one or more PPUs included within the parallel processing subsystem 112 may be configured to perform graphics processing, general purpose processing, and/or compute processing operations. The memory 104 includes at least one device driver configured to manage the processing operations of the one or more PPUs within the parallel processing subsystem 112. Illustratively, the memory 104 includes, without limitation, a video analyzer 110 and an operating system (OS) 111 on which the video analyzer 110 runs. The operating system 140 may be, e.g., Linux®, Microsoft Windows®, or macOS®. In some embodiments, the video analyzer 110 is an application configured to compute one or more quality metrics that are indicative of the quality of a video with synthesized film grain, as discussed in greater detail below in conjunction with FIGS. 3-9. In addition, the video analyzer 110 and/or other application(s) (not shown) can use the computed quality metric(s) in any technically feasible manner, such as to generate a bitrate ladder, to determine whether to stream an encoded video, and/or the like.

In various embodiments, the parallel processing subsystem 112 may be integrated with one or more of the other elements of FIG. 1 to form a single system. For example, the parallel processing subsystem 112 may be integrated with the processor(s) 102 and other connection circuitry on a single chip to form a system on a chip (SoC).

In some embodiments, the communication path 113 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, the system memory 104 could be connected to the processor(s) 102 directly rather than through the memory bridge 114, and other devices may communicate with the system memory 104 via the memory bridge 114 and the processor(s) 102. In other embodiments, the parallel processing subsystem 112 may be connected to the I/O bridge 120 or directly to the processor(s) 102, rather than to memory bridge 114. In still other embodiments, the I/O bridge 120 and the memory bridge 114 may be integrated into a single chip instead of existing as one or more discrete devices. In certain embodiments, one or more components shown in FIG. 1 may not be present. For example, the switch 126 could be eliminated, and the network adapter 130 and the add-in cards 124, 128 would connect directly to the I/O bridge 120. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as virtual graphics processing unit(s) (vGPU(s)) that renders graphics on a virtual machine(s) (VM(s)) executing on a server machine(s) whose GPU(s) and other physical resources are shared across one or more VMs.

### Determining the Quality of Videos with Synthesized Film Grain

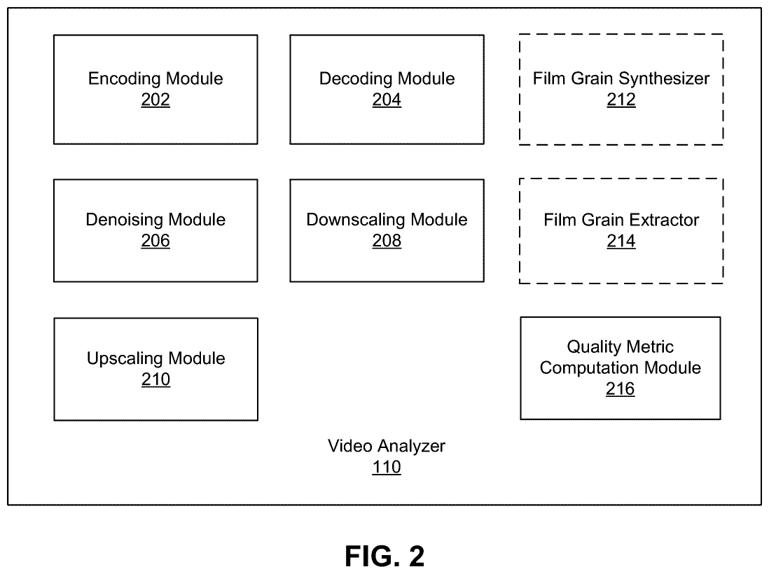

FIG. 2 is a more detailed illustration of the video analyzer 110 of FIG. 1, according to various embodiments. As shown, the video analyzer 110 includes an encoding module 202, a decoding module 204, a denoising module 206, an upscaling module 208, a downscaling module 210, an optional film grain extractor 212, an optional film grain synthesizer 214, and a quality metric computation module 216.

The encoding module 202 is configured to convert an input video into a compressed format for storage, transmission, and/or display. In some embodiments, the encoding module 202 can apply any technically feasible compression technique and/or encoding schemes to transform raw video data into one or more optimized, standardized formats.

The decoding module 204 is configured to convert an input video that is encoded back into a viewable video format by reversing the operations performed by the encoding module 202, thereby reconstructing the original frames of the video prior to encoding. The decoding module 204 can apply any technically feasible decompression technique and/or decoding schemes in some embodiments.

The denoising module 206 is configured to remove noise, such as film grain, from the frames of an input video. The denoising module 206 can analyze the pixel values within each frame to identify and eliminate the noise while preserving important details of the frame. In some embodiments, the denoising module 206 can apply any technically feasible spatial filtering, wavelet transform, and/or machine learning techniques to differentiate between actual image data and noise, and then replace the noise with more accurate pixel values based on the surrounding context.

The downscaling module 208 is configured to reduce the resolution of an input video, effectively lowering the overall quality of the video and decreasing the file size. In some embodiments, the downscaling module 208 can apply any technically feasible pixel averaging and/or filtering techniques to perform the downscaling.

The upscaling module 210 is configured to take as input a video and mathematically calculate and generate additional pixels to increase the resolution of frames of the video. In some embodiments, the upscaling module 210 can apply any technically feasible interpolation technique to generate the additional pixels for each frame of the video.

The film grain synthesizer 213 is a module of the video analyzer 110 that is configured to synthesize film grain for an input video. In some embodiments, the film grain synthesizer 214 can compute the coefficients of an autoregressive model, compute a film grain template using the coefficients, and apply portions thereof as film grain to the frames of a video. In some embodiments, the coefficients of the autoregressive model can be computed according to the techniques disclosed in U.S. Pat. No. 10,839,489, which is incorporated by reference herein in its entirety.

The film grain extractor 212 is a module of the video analyzer 110 that is configured to extract film grain from the frames of an input video. In some embodiments, the film grain extractor 212 can extract film grain from a source video at an original resolution. In such cases, the film grain extractor 212 can compute a difference between the source video and a denoised version of the source video that is generated by processing the source video using the denoising module 206. As used herein, a difference between two videos can include differences between pixel values in corresponding frames of the two videos. In some embodiments, the film grain extractor 212 can extract film grain by computing a difference between a downscaled version of a source video that is generated by processing the source video using the downscaling module 208 and a denoised version of the downscaled source video that is generated by processing the downscaled source video using the denoising module 206. In some embodiments, the film grain extractor 212 can extract film grain by computing a difference between a downscaled version of a source video that is generated by processing the source video using the downscaling module 208 and a downscaled and denoised version of the source video that is generated by (1) processing the source video using the denoising module 206 to generate a denoised video, and (2) processing the denoised video using the downscaling module 208.

The quality metric computation module 216 is configured to compute a quality score that is indicative of the quality of a video with synthesized film grain. In some embodiments, the quality metric computation module 216 can compute the quality score using one or more quality metrics. In some embodiments, the quality metric computation module 216 can compute a quality metric that is a metric of comparison between (1) a first comparison video that is generated from a source video or the source video itself, and (2) a second comparison video that is generated from a decoded video. In some embodiments, to obtain the first and second comparison videos, the quality metric computation module 216 can either add to the source video synthesized film grain that is identical to the film grain in a reconstructed video or apply the original (potentially downsampled or low-pass filtered) film grain from the source video to a reconstructed video instead of synthesized grain, as discussed in greater detail below in conjunction with FIGS. 3-9. Doing so takes into account effects of the film grain error masking without having a penalty from different grain locations in the source and reconstructed videos.

In some embodiments, the quality metric computation module 216 can compute any technically feasible quality metric(s) using the first and second comparison videos. For example, in some embodiments, the video multimethod assessment fusion (VMAF) technique can be used. As another example, in some embodiments, the peak signal-to-noise ratio (PSNR) technique can be used.

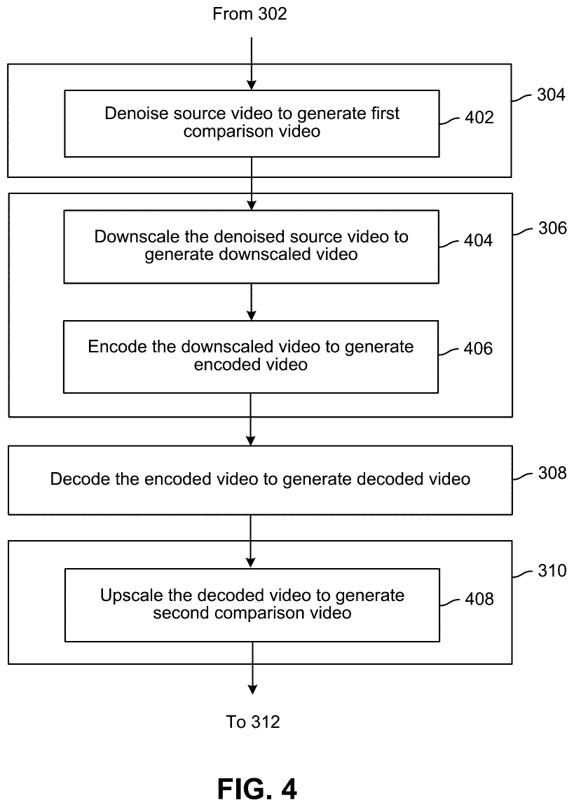

In some embodiments, the quality metric computation module 216 can compute a quality metric that compares (1) a first comparison video that is a denoised version of a source video, and (2) a second comparison video that is an upscaled version of a decoded video, as discussed in greater detail below in conjunction with FIG. 4. In such cases, the decoded video is generated by decoding an encoded version of the source video. Further, use of such first and second comparison videos can help ameliorate the sensitivity of some quality metrics, such as VMAF, to grain locations, and the decoded video also does not need to be renoised. Although described herein primarily with respect to upscaling decoded videos as a reference example, in some embodiments, upscaling can be optional, and whether upscaling is performed will generally depend on whether the source video was previously downscaled, such as if the source video was previously downscaled and encoded at a lower resolution. In such cases, upscaling can be omitted when the source video is not downscaled.

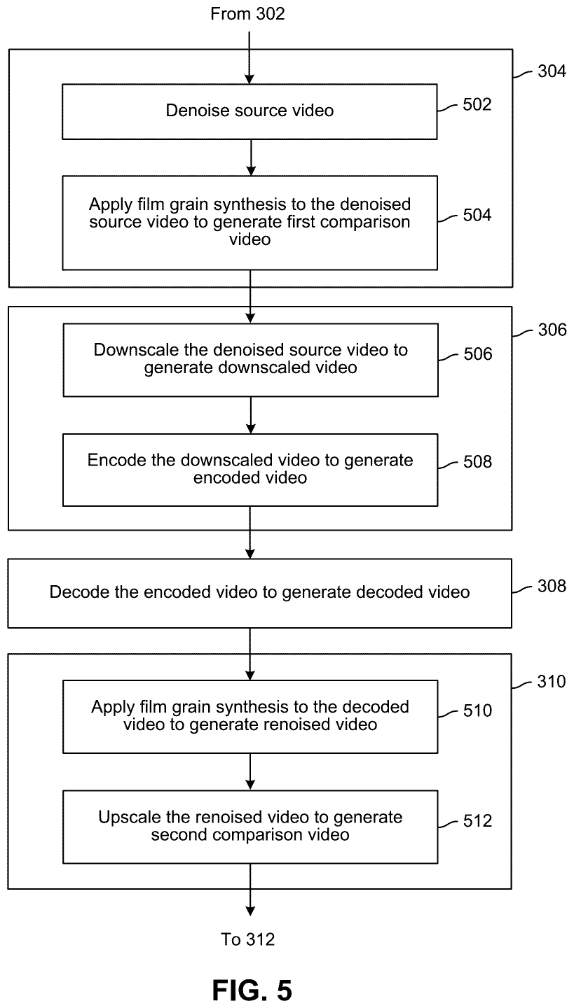

In some embodiments, the quality metric computation module 216 can compute a quality metric that compares (1) a first comparison video that is generated by applying film grain synthesis to a denoised version of a source video, and (2) a second comparison video that is an (optionally) upscaled version of a decoded video to which film grain synthesis has been applied, such that the denoised version of the source video to which synthesized film grain was applied and the (optionally) upscaled version of the decoded video include the same synthesized film grain, as discussed in greater detail below in conjunction with FIG. 5. Use of such first and second comparison videos can help ameliorate the sensitivity of some quality metrics, such as VMAF, to grain locations, while still being able to measure the spatial masking effect of film grain synthesis due to, e.g., VMAF features using localized filtering. Further, one source video can be used as the anchor for all film grain synthesis encodes.

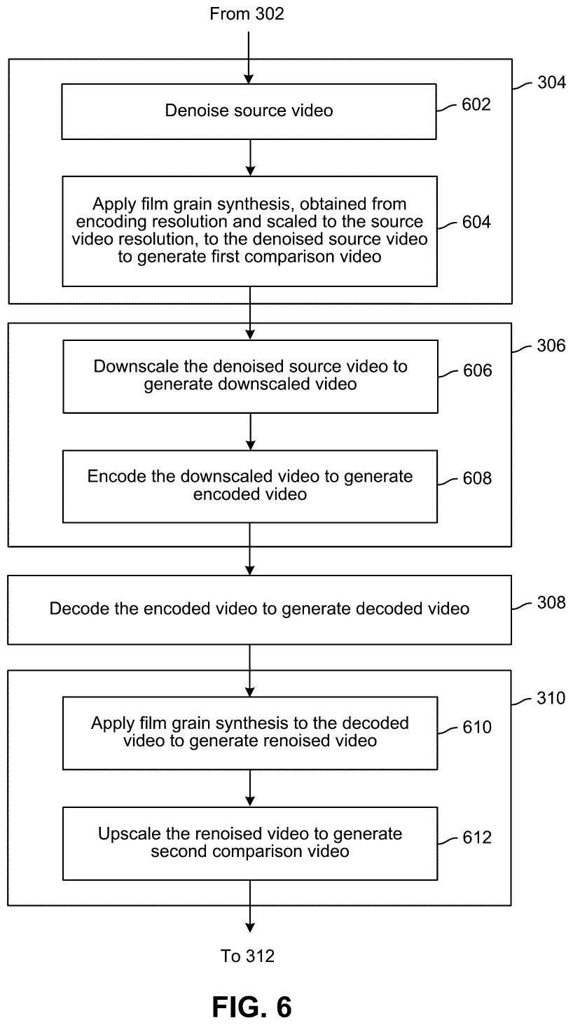

In some embodiments, the quality metric computation module 216 can compute a quality metric that compares (1) a first comparison video that is generated by applying film grain synthesis, obtained from an encoding resolution and scaled to a source video resolution, to a denoised version of a source video; and (2) a second comparison video that is an (optionally) upscaled version of a decoded video to which film grain synthesis has been applied such that the denoised version of the source video to which synthesized film grain was applied and the (optionally) upscaled version of the decoded video include the same synthesized film grain, as discussed in greater detail below in conjunction with FIG. 6. Use of such first and second comparison videos, in addition to ameliorating the sensitivity of some quality metrics, such as VMAF, to grain locations, can also help ensure that lower resolutions are not negatively biased.

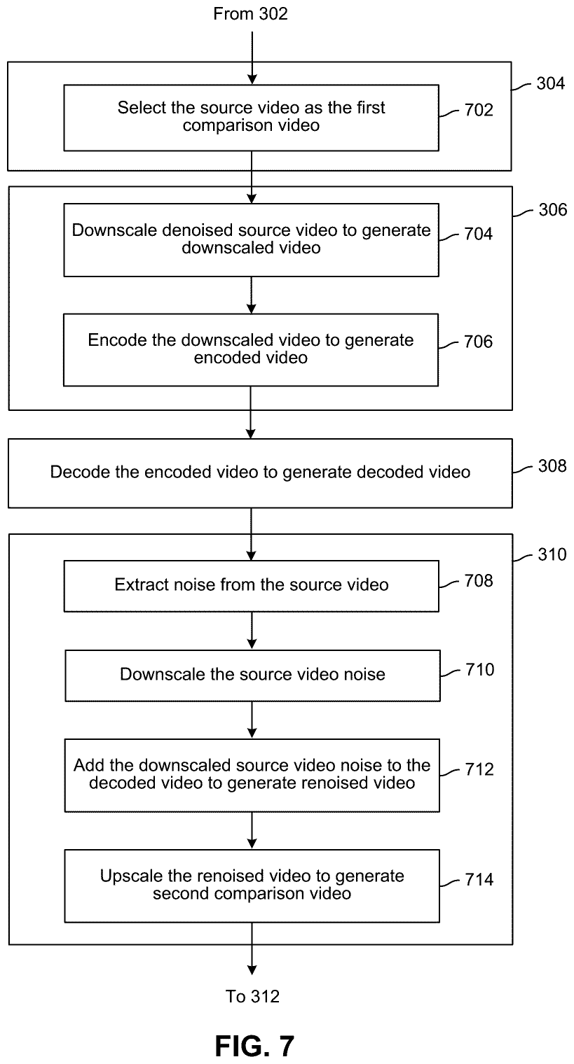

In some embodiments, the quality metric computation module 216 can compute a quality metric that compares (1) a first comparison video that is a source video; and (2) a second comparison video that is generated by extracting noise from the source video, downscaling the source video noise, adding the downscaled source video noise to a decoded video to generate a renoised video, and upscaling the renoised video, as discussed in greater detail below in conjunction with FIG. 7. As used herein, adding (or subtracting) two videos can include adding (or subtracting) pixel values of corresponding frames from the two videos to generate another video. The renoised video is a video that includes noise, such as film grain, as opposed to a denoised video that does not include substantial amounts of noise. Use of such first and second comparison videos, in addition to ameliorating the sensitivity of some quality metrics, such as VMAF, to grain locations, is relatively easy to implement because film grain does not need to be generated for the source video, and all operations related to the source video can be performed with the source video data. In addition, such an approach takes into consideration that the noise is low-pass filtered due to downsampling, which takes into account encoding videos at lower resolutions.

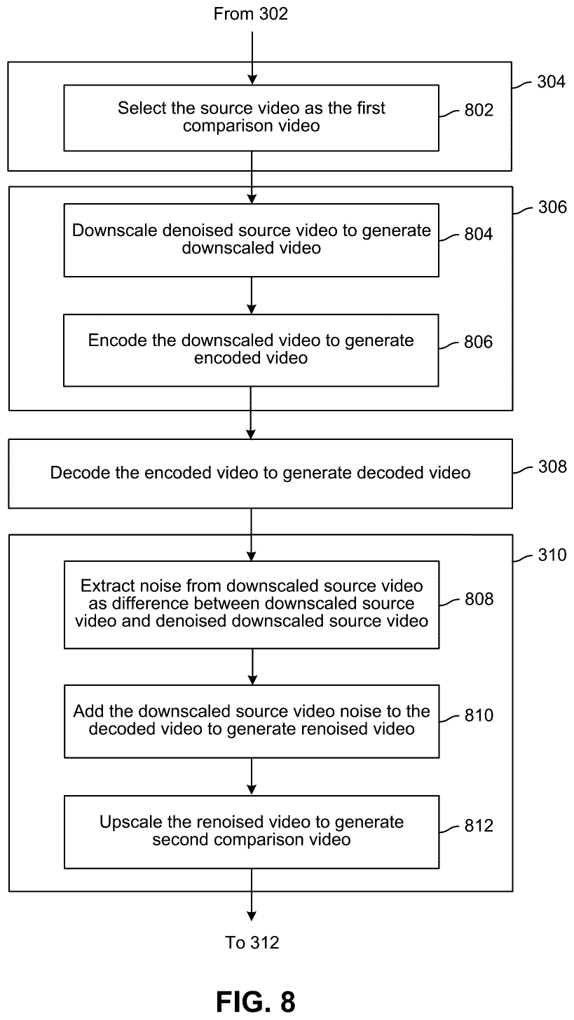

In some embodiments, the quality metric computation module 216 can compute a quality metric that compares (1) a first comparison video that is a source video; and (2) a second comparison video that is generated by extracting noise from a downscaled source video as a difference between the downscaled source video and a denoised downscaled source video, and adding the downscaled source video noise to the decoded video to generate a renoised video, and upscaling the renoised video, as discussed in greater detail below in conjunction with FIG. 8. Use of such first and second comparison videos, in addition to ameliorating the sensitivity of some quality metrics, such as VMAF, to grain locations, is also relatively easy to implement because film grain does not need to be generated for the source video, which is directly used as the first comparison video.

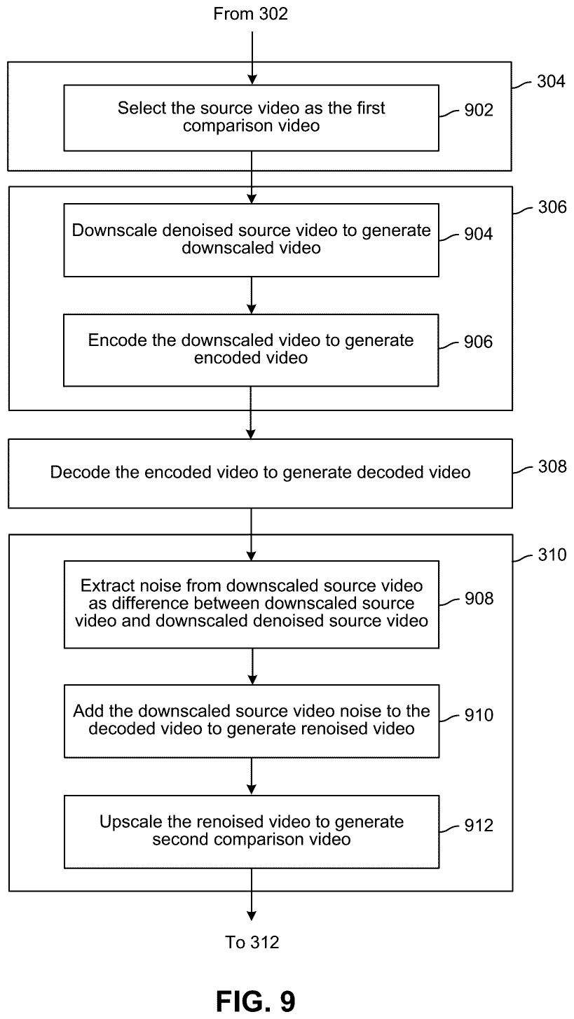

In some embodiments, the quality metric computation module 216 can compute a quality metric that compares (1) a first comparison video that is a source video; and (2) a second comparison video that is generated by extracting noise from a downscaled source video as a difference between the downscaled source video and a downscaled denoised source video, and adding the downscaled source video noise to the decoded video to generate a renoised video, as discussed in greater detail below in conjunction with FIG. 9. Use of such first and second comparison videos, in addition to ameliorating the sensitivity of some quality metrics, such as VMAF, to grain locations, is also relatively easy to implement because film grain does not need to be generated for the source video, downscaling and adding the noise can also be relatively easy to perform.

In some embodiments, the video analyzer 110 and/or other application(s) can use the computed quality metric(s) in any technically feasible manner. For example, in some embodiments, computed quality metrics for different encoded versions of a video can be used to generate a bitrate ladder. In such cases, the bitrate ladder can be generated according to the techniques disclosed in U.S. Pat. No. 11,677,797, which is incorporated by reference herein in its entirety. Thereafter, a server can use the bitrate ladder to dynamically adjust the quality of video content being delivered to a client device based on network conditions and capabilities of the client device, in order to ensure the smooth playback of video content on the client device. As another example, in some embodiments, computed quality metrics for different encoded versions of a video can be used, in conjunction with bandwidth information, to select which encoded version of the video to stream to a client device. In such cases, a lower quality encoding can be selected when the bandwidth is constrained to ensure that the encoded video fits into the available bandwidth, and vice versa. As yet another example, in some embodiments, computed quality metrics for different encoded versions of a video can be transmitted to a client device, which can use such quality metrics to select one of the encoded versions to stream.

FIG. 3 is a flow diagram of method steps for determining the quality of a video with synthesized film grain, according to various embodiments. Although the method steps are described with reference to the systems of FIGS. 1-2, persons skilled in the art will understand that any system configured to implement the method steps, in any order, falls within the scope of the present disclosure.

As shown, a method 300 begins at step 302, where the video analyzer 110 receives a source video.

At step 304, the video analyzer 110 either generates a first comparison video based on the source video or selects the source video as the first comparison video. Selecting the source video as the first comparison video is also sometimes referred to herein as generating the first comparison video. In some embodiments, the first comparison video can be a denoised version of the source video, as discussed in greater detail below in conjunction with FIG. 4. In some embodiments, the video analyzer 110 can generate the first comparison video by applying film grain synthesis to a denoised version of the source video, as discussed in greater detail below in conjunction with FIG. 5. In some embodiments, the video analyzer 110 can generate the first source video by applying film grain synthesis, obtained from an encoding resolution and scaled to a source video resolution, to a denoised version of the source video, as discussed in greater detail below in conjunction with FIG. 6. In some embodiments, the video analyzer 110 can select the source video as the first comparison video, as discussed in greater detail below in conjunction with FIGS. 7-9.

At step 306, the video analyzer 110 generates an encoded video based on the source video. In some embodiments, the video analyzer 110 can apply any technically feasible compression technique and/or encoding schemes to transform raw video data of the source video, or another video that is generated from the source video, into one or more optimized, standardized formats, as discussed in greater detail below in conjunction with FIGS. 4-9.

At step 308, the video analyzer 110 decodes the encoded video to generate a decoded video. In some embodiments, the video analyzer 110 can reverse the operations performed during encoding, such as by applying any technically feasible decompression technique and/or decoding schemes, to generate the decoded video.

At step 310, the video analyzer 110 generates the second comparison video based on the decoded video. In some embodiments, the second comparison video can be an upscaled version of the decoded video, as discussed in greater detail below in conjunction with FIG. 4. In some embodiments, the video analyzer 110 can generate the second comparison video by applying film grain synthesis to the decoded video and upscaling the decoded video with the film grain, such that a denoised version of the source video to which synthesized film grain was applied and the upscaled version of the decoded video include the same synthesized film grain, as discussed in greater detail below in conjunction with FIG. 5. In some embodiments, the video analyzer 110 can generate the second comparison video by applying film grain synthesis to a decoded video that is then upscaled, such that a denoised version of the source video to which synthesized film grain was applied and the upscaled version of the decoded video include the same synthesized film grain, as discussed in greater detail below in conjunction with FIG. 6. In some embodiments, the video analyzer 110 can generate the second comparison video by extracting noise from the source video, downscaling the source video noise, adding the downscaled source video noise to the decoded video to generate a renoised video, and upscaling the renoised video, as discussed in greater detail below in conjunction with FIG. 7. In some embodiments, the video analyzer 110 can generate the second comparison video by extracting noise from a downscaled source video as a difference between the downscaled source video and a denoised downscaled source video, adding the downscaled source video noise to the decoded video to generate a renoised video, and upscaling the renoised video, as discussed in greater detail below in conjunction with FIG. 8. In some embodiments, the video analyzer 110 can generate the second comparison video by extracting noise from a downscaled source video as a difference between the downscaled source video and a downscaled denoised source video, adding the downscaled source video noise to the decoded video to generate a renoised video, and upscaling the renoised video, as discussed in greater detail below in conjunction with FIG. 9.

At step 312, the video analyzer 110 computes a video quality score using the first and second comparison videos. In some embodiments, the video analyzer 110 can compute the video quality score using any technically feasible quality metric. For example, in some embodiments, a VMAF or PSNR metric can be computed by the video analyzer 110 using the first and second comparison videos.

As described, in some embodiments, the quality metric computed at step 312 can be used by the video analyzer 110 and/or other application(s) in any technically feasible manner. For example, in some embodiments, computed quality metrics for different encoded versions of a video can be used to generate a bitrate ladder. As another example, in some embodiments, computed quality metrics for different encoded versions of a video can be used, in conjunction with bandwidth information, to select which encoded version of the video to stream to a client device. As yet another example, in some embodiments, computed quality metrics for different encoded versions of a video can be transmitted to a client device, which can use such quality metrics to select one of the encoded versions to stream.

FIG. 4 is a flow diagram of method steps for generating comparison videos, according to various embodiments. Although the method steps are described with reference to the systems of FIGS. 1-2, persons skilled in the art will understand that any system configured to implement the method steps, in any order, falls within the scope of the present disclosure.

As shown, at step 402, the video analyzer 110 denoises the source video to generate the first comparison video. In some embodiments, the video analyzer 110 can analyze the pixel values within each frame of the source video to identify and eliminate noise while preserving important details of the frame, such as by performing a spatial filtering, wavelet transform, and/or machine learning technique.

At step 404, the video analyzer 110 downscales the denoised source video to generate a downscaled video. In some embodiments, the video analyzer 110 can downscale the denoised source video by applying a pixel averaging, filtering, or any other technically feasible technique to reduce a resolution of frames of the denoised source video.

At step 406, the video analyzer 110 encodes the downscaled video to generate an encoded video. In some embodiments, the video analyzer 110 can encode the downscaled video by applying any technically feasible compression technique and/or encoding schemes to transform raw video data of the downscaled video into one or more optimized, standardized formats.

At step 408, which is performed after the video analyzer 110 decodes the encoded video to generate a decoded video at step 308, the video analyzer 110 upscales the decoded video to generate the second comparison video. In some embodiments, the video analyzer 110 can upscale the decoded video by mathematically calculating and generating additional pixels to increase the resolution of frames of the decoded video using, e.g., any technically feasible interpolation technique.

FIG. 5 is a flow diagram of method steps for generating comparison videos, according to various other embodiments. Although the method steps are described with reference to the systems of FIGS. 1-2, persons skilled in the art will understand that any system configured to implement the method steps, in any order, falls within the scope of the present disclosure.

As shown, at step 502, the video analyzer 110 denoises the source video. Step 502 is similar to step 402, described above in conjunction with FIG. 4.

At step 504, the video analyzer 110 applies film grain synthesis to the denoised source video to generate the first comparison video. In some embodiments, the film grain synthesis can include computing the coefficients of an autoregressive model, computing a film grain template using the coefficients, and applying portions thereof as film grain to frames of the denoised source video.

At step 506, the video analyzer 110 downscales the denoised source video to generate a downscaled video. Step 506 is similar to step 404, described above in conjunction with FIG. 4.

At step 508, the video analyzer 110 encodes the downscaled video to generate an encoded video. Step 508 is similar to step 406, described above in conjunction with FIG. 4.

At step 510, which is performed after the video analyzer 110 decodes the encoded video to generate a decoded video at step 308, the video analyzer 110 applies film grain synthesis to the decoded video to generate a renoised video. In some embodiments, a downscaled version of the synthesized film grain that was applied to the denoised source video at step 504 can be applied to the decoded video to generate the renoised video, such that the denoised version of the source video to which synthesized film grain was applied and an upscaled version of the decoded video include the same synthesized film grain.

At step 512, the video analyzer 110 upscales the renoised video to generate a second comparison video. In some embodiments, the video analyzer 110 can upscale the renoised video by mathematically calculating and generating additional pixels to increase the resolution of frames of the renoised video using, e.g., any technically feasible interpolation technique.

FIG. 6 is a flow diagram of method steps for generating comparison videos, according to various other embodiments. Although the method steps are described with reference to the systems of FIGS. 1-2, persons skilled in the art will understand that any system configured to implement the method steps, in any order, falls within the scope of the present disclosure.

As shown, at step 602, the video analyzer 110 denoises the source video. Step 502 is similar to step 402, described above in conjunction with FIG. 4.

At step 604, the video analyzer 110 applies film grain synthesis, obtained from an encoding resolution and scaled to the source video resolution, to the denoised source video to generate first comparison video. In some embodiments, the film grain synthesis can include, at the encoding resolution, computing the coefficients of an autoregressive model, computing a film grain template using the coefficients, and applying portions thereof as film grain, and then upscaling the film grain at the encoding resolution to the resolution of the source video.

At step 606, the video analyzer 110 downscales the denoised source video to generate a downscaled video. Step 606 is similar to step 404, described above in conjunction with FIG. 4.

At step 608, the video analyzer 110 encodes the downscaled video to generate an encoded video. Step 608 is similar to step 406, described above in conjunction with FIG. 4.

At step 610, which is performed after the video analyzer 110 decodes the encoded video to generate a decoded video at step 308, the video analyzer 110 applies film grain synthesis to the decoded video to generate a renoised video. In some embodiments, the film grain that is applied can be the same film grain that was generated at the encoding resolution at step 604.

At step 612, the video analyzer 110 upscales the renoised video to generate a second comparison video. Step 612 is similar to step 512, described above in conjunction with FIG. 5.

FIG. 7 is a flow diagram of method steps for generating comparison videos, according to various other embodiments. Although the method steps are described with reference to the systems of FIGS. 1-2, persons skilled in the art will understand that any system configured to implement the method steps, in any order, falls within the scope of the present disclosure.

As shown, at step 702, the video analyzer 110 selects the source video as the first comparison video. That is, the video analyzer 110 uses the source video as the first comparison video, rather than generating a substitute video.

At step 704, the video analyzer 110 downscales a denoised version of the source video to generate a downscaled video. In some embodiments, the video analyzer 110 can denoise the source video by analyzing the pixel values within each frame of the source video to identify and eliminate noise while preserving important details of the frame, such as by performing a spatial filtering, wavelet transform, and/or machine learning technique. Then, the video analyzer 110 can downscale the denoised source video to generate the downscaled video by applying a pixel averaging, filtering, or any other technically feasible technique to reduce a resolution of frames of the denoised source video.

At step 706, the video analyzer 110 encodes the downscaled video to generate an encoded video. Step 706 is similar to step 406, described above in conjunction with FIG. 4.

At step 708, which is performed after the video analyzer 110 decodes the encoded video to generate a decoded video at step 308, the video analyzer 110 extracts noise from the source video. The noise that is extracted can include film grain in frames of the source video. In some embodiments, the video analyzer 110 can extract noise from the source video by subtracting, from frames of the source video, pixel values from corresponding frames of the denoised version of the source video.

At step 710, the video analyzer 110 downscales the source video noise. In some embodiments, the video analyzer 110 can downscale the source video noise by applying a pixel averaging, filtering, or any other technically feasible technique to reduce a resolution of images (corresponding to frames of the source video) that include the source video noise.

At step 712, the video analyzer 110 adds the downscaled source video noise to the decoded video to generate a renoised video. The video analyzer 110 can add the downscaled source video noise in each of a number of images to corresponding frames of the decoded video to generate the renoised video.

At step 714, the video analyzer 110 upscales the renoised video to generate a second comparison video. Step 714 is similar to step 512, described above in conjunction with FIG. 5.

FIG. 8 is a flow diagram of method steps for generating comparison videos, according to various other embodiments. Although the method steps are described with reference to the systems of FIGS. 1-2, persons skilled in the art will understand that any system configured to implement the method steps, in any order, falls within the scope of the present disclosure.

As shown, at step 802, the video analyzer 110 selects the source video as the first comparison video. That is, the video analyzer 110 uses the source video as the first comparison video, rather than generating a substitute video.

At step 804, the video analyzer 110 downscales a denoised version of the source video to generate a downscaled video. Step 804 is similar to step 704, described above in conjunction with FIG. 7.

At step 806, the video analyzer 110 encodes the downscaled video to generate an encoded video. Step 806 is similar to step 406, described above in conjunction with FIG. 4.

At step 808, which is performed after the video analyzer 110 decodes the encoded video to generate a decoded video at step 308, the video analyzer 110 extracts noise from a downscaled source video as the difference between a downscaled source video and a denoised downscaled source video. The denoised downscaled source video can be generated by downscaling the source video, and then denoising the downscaled version of the source video. The video analyzer 110 can subtract frames of the denoised downscaled source video from corresponding frames of the downscaled source video to extract noise, which can include film grain, from the downscaled source video.

At step 810, the video analyzer 110 adds the downscaled source video noise to the decoded video to generate a renoised video. Step 810 is similar to step 712, described above in conjunction with FIG. 7.

At step 812, the video analyzer 110 upscales the renoised video to generate the second comparison video. Step 812 is similar to step 512, described above in conjunction with FIG. 5.

FIG. 9 is a flow diagram of method steps for generating comparison videos, according to various other embodiments. Although the method steps are described with reference to the systems of FIGS. 1-2, persons skilled in the art will understand that any system configured to implement the method steps, in any order, falls within the scope of the present disclosure.

As shown, at step 902, the video analyzer 110 selects the source video as the first comparison video. That is, the video analyzer 110 uses the source video as the first comparison video, rather than generating a substitute video.

At step 904, the video analyzer 110 downscales a denoised version of the source video to generate a downscaled video. Step 904 is similar to step 704, described above in conjunction with FIG. 7.

At step 906, the video analyzer 110 encodes the downscaled video to generate an encoded video. Step 906 is similar to step 406, described above in conjunction with FIG. 4.

At step 908, which is performed after the video analyzer 110 decodes the encoded video to generate a decoded video at step 308, the video analyzer 110 extracts noise from a downscaled source video as the difference between a downscaled source video and a downscaled denoised source video. The downscaled denoised source video can be generated by denoising the source video, and then downscaling the denoised version of the source video. The video analyzer 110 can subtract frames of the downscaled denoised source video from corresponding frames of the downscaled source video to extract noise, which can include film grain, from the downscaled source video. Step 908 is similar to step 808, described above in conjunction with FIG. 8, except the downscaled denoised source video is used rather than a denoised downscaled source video to extract the noise from the downscaled source video.

At step 910, the video analyzer 110 adds the downscaled source video noise to the decoded video to generate renoised video. Step 910 is similar to step 712, described above in conjunction with FIG. 7.

At step 912, the video analyzer 110 upscales the renoised video to generate the second comparison video. Step 912 is similar to step 512, described above in conjunction with FIG. 5.

### Exemplar System Architecture

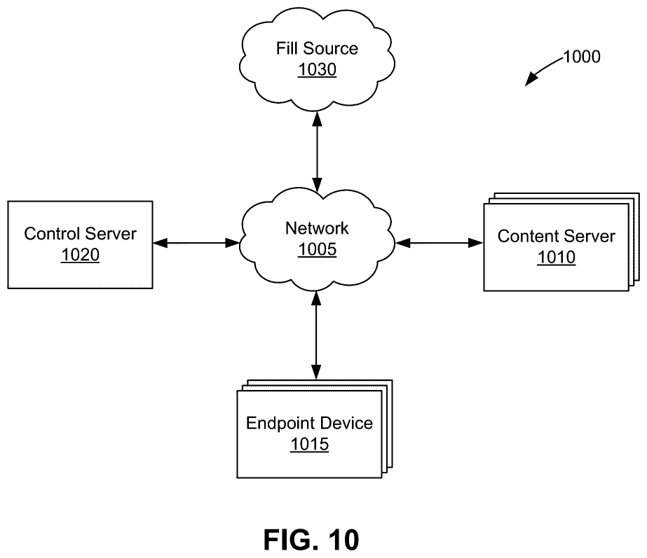

FIGS. 10-13 illustrate an exemplar architecture of a system in which various embodiments can be implemented. FIG. 10 illustrates a network infrastructure 1000 used to distribute content to content servers 1010 and endpoint devices 1015, according to various embodiments. As shown, the network infrastructure 1000 includes content servers 1010, control server 1020, and endpoint devices 1015, each of which are connected via a communications network 1005.

Each endpoint device 1015 communicates with one or more content servers 1010 (also referred to as “caches” or “nodes”) via the network 1005 to download content, such as textual data, graphical data, audio data, video data, and other types of data. The downloadable content, also referred to herein as a “file,” is then presented to a user of one or more endpoint devices 1015. In various embodiments, the endpoint devices 1015 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 1010 may include a web-server, database, and server application configured to communicate with the control server 1020 to determine the location and availability of various files that are tracked and managed by the control server 1020. Each content server 1010 may further communicate with a fill source 1030 and one or more other content servers 1010 in order “fill” each content server 1010 with copies of various files. In addition, content servers 1010 may respond to requests for files received from endpoint devices 1015. The files may then be distributed from the content server 1010 or via a broader content distribution network. In some embodiments, the content servers 1010 enable users to authenticate (e.g., using a username and password) in order to access files stored on the content servers 1010. Although only a single control server 1020 is shown in FIG. 10, in various embodiments multiple control servers 120 may be implemented to track and manage files.

In various embodiments, the fill source 1030 may include an online storage service (e.g., Amazon® Simple Storage Service, Google® Cloud Storage, etc.) in which a catalog of files, including thousands or millions of files, is stored and accessed in order to fill the content servers 1010. Although only a single fill source 1030 is shown in FIG. 10, in various embodiments multiple fill sources 1030 may be implemented to service requests for files. Further, as is well-understood, any cloud-based services can be included in the architecture of FIG. 10 beyond fill source 1030 to the extent desired or necessary.

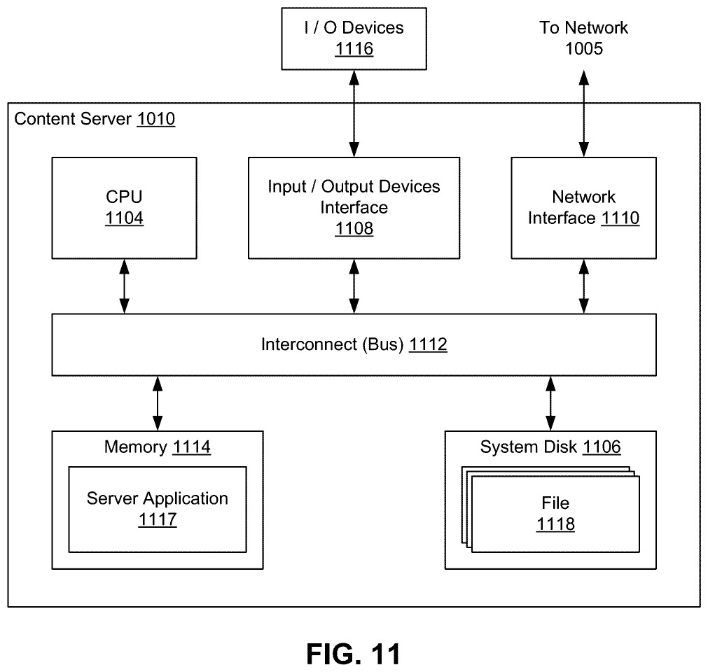

FIG. 11 is a block diagram of a content server 1010 that may be implemented in conjunction with the network infrastructure 1000 of FIG. 10, according to various embodiments. As shown, the content server 1010 includes, without limitation, a central processing unit (CPU) 1104, a system disk 1106, an input/output (I/O) devices interface 1108, a network interface 1110, an interconnect 1112, and a system memory 1114.

The CPU 1104 is configured to retrieve and execute programming instructions, such as server application 1117, stored in the system memory 1114. Similarly, the CPU 1104 is configured to store application data (e.g., software libraries) and retrieve application data from the system memory 1114. The interconnect 1112 is configured to facilitate transmission of data, such as programming instructions and application data, between the CPU 1104, the system disk 1106, I/O devices interface 1108, the network interface 1110, and the system memory 1114. The I/O devices interface 1108 is configured to receive input data from I/O devices 1116 and transmit the input data to the CPU 1104 via the interconnect 1112. For example, I/O devices 1116 may include one or more buttons, a keyboard, a mouse, and/or other input devices. The I/O devices interface 1108 is further configured to receive output data from the CPU 1104 via the interconnect 1112 and transmit the output data to the I/O devices 1116.

The system disk 1106 may include one or more hard disk drives, solid state storage devices, or similar storage devices. The system disk 1106 is configured to store non-volatile data such as files 1118 (e.g., audio files, video files, subtitles, application files, software libraries, etc.). The files 1118 can then be retrieved by one or more endpoint devices 1015 via the network 1005. In some embodiments, the network interface 1110 is configured to operate in compliance with the Ethernet standard.

The system memory 1114 includes a server application 1117 configured to service requests for files 1118 received from endpoint device 1015 and other content servers 1010. When the server application 1117 receives a request for a file 1118, the server application 1117 retrieves the corresponding file 1118 from the system disk 1106 and transmits the file 1118 to an endpoint device 1015 or a content server 1010 via the network 1005.

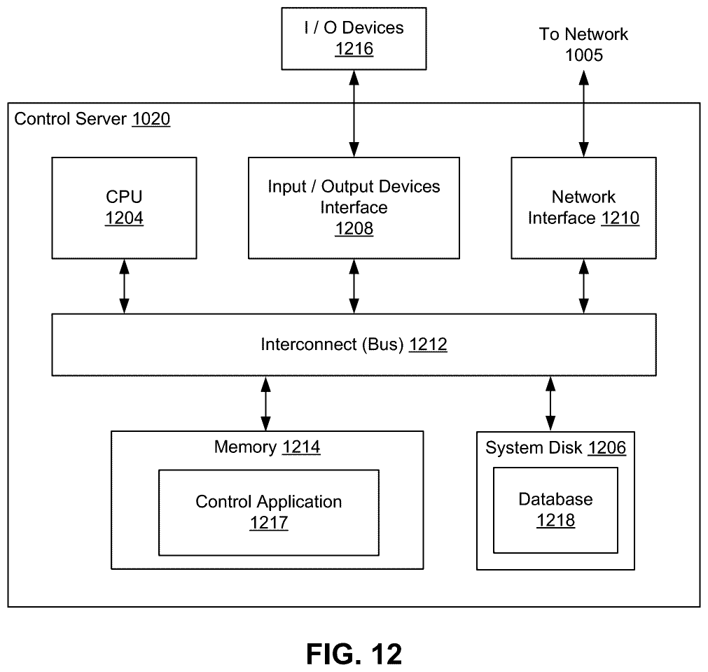

FIG. 12 is a block diagram of a control server 1020 that may be implemented in conjunction with the network infrastructure 1000 of FIG. 10, according to various embodiments. As shown, the control server 1020 includes, without limitation, a central processing unit (CPU) 1204, a system disk 1206, an input/output (I/O) devices interface 1208, a network interface 1210, an interconnect 1212, and a system memory 1214.

The CPU 1204 is configured to retrieve and execute programming

instructions, such as control application 1217, stored in the system memory 1214. Similarly, the CPU 1204 is configured to store application data (e.g., software libraries) and retrieve application data from the system memory 1214 and a database 1218 stored in the system disk 1206. The interconnect 1212 is configured to facilitate transmission of data between the CPU 1204, the system disk 1206, I/O devices interface 1208, the network interface 1210, and the system memory 1214. The I/O devices interface 1208 is configured to transmit input data and output data between the I/O devices 1216 and the CPU 1204 via the interconnect 1212. The system disk 1206 may include one or more hard disk drives, solid state storage devices, and the like. The system disk 1106 is configured to store a database 1218 of information associated with the content servers 1010, the fill source(s) 1030, and the files 1118.

The system memory 1214 includes a control application 1217 configured to access information stored in the database 1218 and process the information to determine the manner in which specific files 1118 will be replicated across content servers 1010 included in the network infrastructure 1000. The control application 1217 may further be configured to receive and analyze performance characteristics associated with one or more of the content servers 1010 and/or endpoint devices 1015.

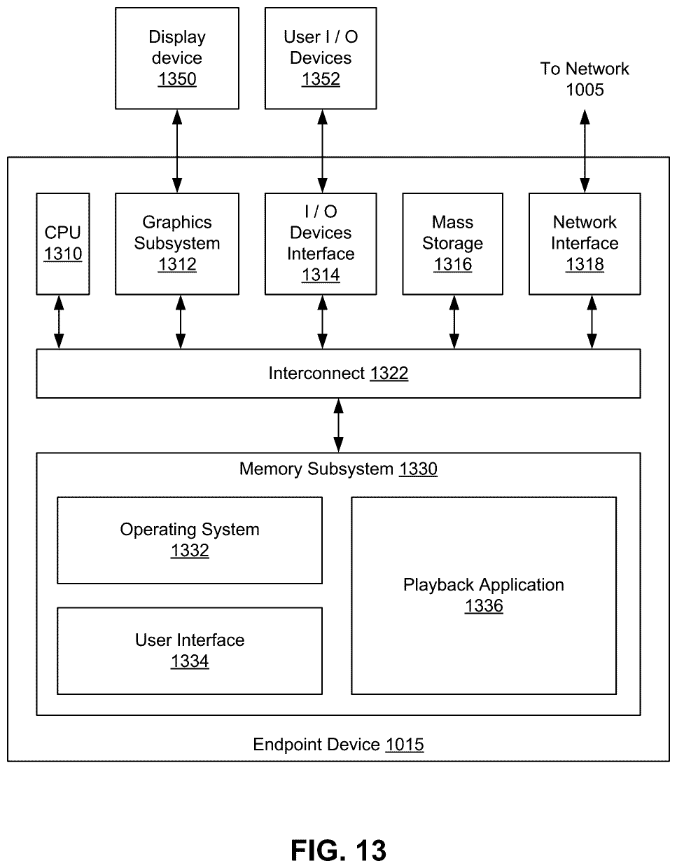

FIG. 13 is a block diagram of an endpoint device 1015 that may be implemented in conjunction with the network infrastructure 1000 of FIG. 10, according to various embodiments. As shown, the endpoint device 1015 may include, without limitation, a CPU 1310, a graphics subsystem 1312, an I/O device interface 1314, a mass storage unit 1316, a network interface 1318, an interconnect 1322, and a memory subsystem 1330.

In some embodiments, the CPU 1310 is configured to retrieve and execute programming instructions stored in the memory subsystem 1330. Similarly, the CPU 1310 is configured to store and retrieve application data (e.g., software libraries) residing in the memory subsystem 1330. The interconnect 1322 is configured to facilitate transmission of data, such as programming instructions and application data, between the CPU 1310, graphics subsystem 1312, I/O devices interface 1314, mass storage 1316, network interface 1318, and memory subsystem 1330.

In some embodiments, the graphics subsystem 1312 is configured to generate frames of video data and transmit the frames of video data to display device 1350. In some embodiments, the graphics subsystem 1312 may be integrated into an integrated circuit, along with the CPU 1310. The display device 1350 may comprise any technically feasible means for generating an image for display. For example, the display device 1350 may be fabricated using liquid crystal display (LCD) technology, cathode-ray technology, and light-emitting diode (LED) display technology. An input/output (I/O) device interface 1314 is configured to receive input data from user I/O devices 1352 and transmit the input data to the CPU 1310 via the interconnect 1322. For example, user I/O devices 1352 may comprise one of more buttons, a keyboard, and a mouse or other pointing device. The I/O device interface 1314 also includes an audio output unit configured to generate an electrical audio output signal. User I/O devices 1352 includes a speaker configured to generate an acoustic output in response to the electrical audio output signal. In alternative embodiments, the display device 1350 may include the speaker. A television is an example of a device known in the art that can display video frames and generate an acoustic output.

A mass storage unit 1316, such as a hard disk drive or flash memory storage drive, is configured to store non-volatile data. A network interface 1318 is configured to transmit and receive packets of data via the network 1005. In some embodiments, the network interface 1318 is configured to communicate using the well-known Ethernet standard. The network interface 1318 is coupled to the CPU 1310 via the interconnect 1322.

In some embodiments, the memory subsystem 1330 includes programming instructions and application data that comprise an operating system 1332, a user interface 1334, and a playback application 1336. The operating system 1332 performs system management functions such as managing hardware devices including the network interface 1318, mass storage unit 1316, I/O device interface 1314, and graphics subsystem 1312. The operating system 1332 also provides process and memory management models for the user interface 1334 and the playback application 1336. The user interface 1334, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 1336 is configured to request and receive content from a content server 1010 via the network interface 1318. Further, the playback application 1336 is configured to interpret the content and present the content via display device 1350 and/or user I/O devices 1352.

In sum, techniques are disclosed for determining the quality of videos with synthesized film grain. A video analyzer computes one or more quality metrics, which are indicative of the quality of a video with synthesized film grain, using (1) a first comparison video that is either a source video or is generated from a source video, and (2) a second comparison video that is generated from a decoded video that is a decoding of an encoded version of the source video. In some embodiments, the video analyzer can compute a quality metric that compares (1) a first comparison video that is a denoised version of the source video, and (2) a second comparison video that is an upscaled version of the decoded video. In some embodiments, the video analyzer can compute a quality metric that compares (1) a first comparison video that is generated by applying film grain synthesis to a denoised version of the source video, and (2) a second comparison video that is an upscaled version of the decoded video, to which film grain synthesis has been applied, such that the denoised version of the source video to which synthesized film grain was applied and the upscaled version of the decoded video include the same synthesized film grain. In some embodiments, the video analyzer can compute a quality metric that compares (1) a first comparison video that is generated by applying film grain synthesis, obtained from an encoding resolution and scaled to a source video resolution, to a denoised version of a source video; and (2) a second comparison video that is an upscaled version of the decoded video, to which film grain synthesis has been applied, such that the denoised version of the source video to which synthesized film grain was applied and the upscaled version of the decoded video include the same synthesized film grain. In some embodiments, the video analyzer can compute a quality metric that compares (1) a first comparison video that is the source video; and (2) a second comparison video that is generated by extracting noise from the source video, downscaling the source video noise, adding the downscaled source video noise to the decoded video to generate a renoised video, and upscaling the renoised video. In some embodiments, the video analyzer can compute a quality metric that compares (1) a first comparison video that is the source video; and (2) a second comparison video that is generated by extracting noise from a downscaled source video as a difference between the downscaled source video and a denoised downscaled source video, and adding the downscaled source video noise to the decoded video to generate a renoised video. In some embodiments, the video analyzer can compute a quality metric that compares (1) a first comparison video that is the source video; and (2) a second comparison video that is generated by extracting noise from a downscaled source video as a difference between the downscaled source video and a downscaled denoised source video, and adding the downscaled source video noise to the decoded video to generate a renoised video. After computing the quality metric(s), the video analyzer and/or other application(s) can use the quality metric(s) to generate a bitrate ladder, to determine whether to stream a corresponding, and/or in another suitable manner.

At least one technical advantage of the disclosed techniques relative to the prior art is that the disclosed techniques enable the quality of reconstructed video content that includes synthesized film grain to be more accurately determined relative to what can be achieved using prior art techniques. Accordingly, the more accurate determinations of video quality that can be obtained via the disclosed techniques can then be used to generate more optimized bitrate ladders for video streaming and to help ensure that video content of more appropriate quality levels for given levels of available network bandwidth can be transmitted to endpoint devices during streaming sessions. These technical advantages represent one or more technological improvements over prior art approaches.
1. In some embodiments, a computer-implemented method for determining video quality for streaming media implementations comprises generating a first comparison video based on a source video, generating an encoded video based on the source video, decoding the encoded video to generate a decoded video, generating a second comparison video based on the decoded video, and computing a video quality score based on the first comparison video and the second comparison video, wherein the encoded video is selected for transmission to a client device based on the video quality score.
2. The computer-implemented method of clause 1, wherein generating the first comparison video comprises denoising the source video, generating the encoded video comprises denoising and downscaling the source video, and generating the second comparison video comprises upscaling the decoded video.
3. The computer-implemented method of clauses 1 or 2, wherein generating the first comparison video comprises denoising the source video to generate a denoised video, and adding first synthesized film grain to the denoised video.
4. The computer-implemented method of any of clauses 1-3, wherein generating the second comparison video comprises adding second synthesized film grain to the decoded video to generate a renoised video, and upscaling the renoised video to generate the second comparison video.
5. The computer-implemented method of any of clauses 1-4, wherein generating the first comparison video comprises computing first film grain at a first resolution, wherein the encoded video has a resolution equal to the first resolution, upscaling the first film grain to a second resolution to generate second film grain, wherein the source video has a resolution equal to the second resolution, and adding the second film grain to a denoised version of the source video to generate the first comparison video.
6. The computer-implemented method of any of clauses 1-5, wherein generating the second comparison video comprises adding the first film grain to the decoded video to generate a renoised video, and upscaling the renoised video to generate the second comparison video.
7. The computer-implemented method of any of clauses 1-6, wherein the video quality score is computed using a video quality metric.
8. The computer-implemented method of any of clauses 1-7, wherein the video quality score is computed using video multimethod assessment fusion (VMAF).
9. The computer-implemented method of any of clauses 1-8, further comprising generating at least a portion of a bitrate ladder using the video quality score.
10. The computer-implemented method of any of clauses 1-9, further comprising transmitting the encoded video to the client device based on the video quality score and a network bandwidth.
11. In some embodiments, one or more non-transitory computer-readable media store instructions that, when executed by at least one processor, cause the at least one processor to perform steps comprising generating a first comparison video based on a source video, generating an encoded video based on the source video, decoding the encoded video to generate a decoded video, generating a second comparison video based on the decoded video, and computing a video quality score based on the first comparison video and the second comparison video, wherein the encoded video is selected for transmission to a client device based on the video quality score.
12. The one or more non-transitory computer-readable media of clause 11, wherein generating the first comparison video comprises denoising the source video, generating the encoded video comprises denoising and downscaling the source video, and generating the second comparison video comprises upscaling the decoded video.
13. The one or more non-transitory computer-readable media of clauses 11 or 12, wherein generating the first comparison video comprises denoising the source video to generate a denoised video, and adding first synthesized film grain to the denoised video.
14. The one or more non-transitory computer-readable media of any of clauses 11-13, wherein generating the second comparison video comprises adding second synthesized film grain to the decoded video to generate a renoised video, and upscaling the renoised video to generate the second comparison video.
15. The one or more non-transitory computer-readable media of any of clauses 11-14, wherein generating the first comparison video comprises computing first film grain at a first resolution, wherein the encoded video has a resolution equal to the first resolution, upscaling the first film grain to a second resolution to generate second film grain, wherein the source video has a resolution equal to the second resolution, and adding the second film grain to a denoised version of the source video to generate the first comparison video.
16. The one or more non-transitory computer-readable media of any of clauses 11-15, wherein generating the second comparison video comprises adding the first film grain to the decoded video to generate a renoised video, and upscaling the renoised video to generate the second comparison video.
17. The one or more non-transitory computer-readable media of any of clauses 11-16, wherein the video quality score is computed using at least one of a video multimethod assessment fusion (VMAF) or a peak signal-to-noise ratio (PSNR) technique.
18. The one or more non-transitory computer-readable media of any of clauses 11-17, wherein the instructions, when executed by the at least one processor, further cause the at least one processor to perform the step of transmitting the video quality score to the client device.
19. The one or more non-transitory computer-readable media of any of clauses 11-18, wherein the client device requests the encoded video based on the video quality score.
20. In some embodiments, a system comprises one or more memories storing instructions, and one or more processors that are coupled to the one or more memories and, when executing the instructions, are configured to generate a first comparison video based on a source video, generate an encoded video based on the source video, decode the encoded video to generate a decoded video, generate a second comparison video based on the decoded video, and compute a video quality score based on the first comparison video and the second comparison video, wherein the encoded video is selected for transmission to a client device based on the video quality score.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for determining video quality for streaming media implementations, the method comprising:
generating a first comparison video based on a source video;
generating an encoded video based on the source video;
decoding the encoded video to generate a decoded video;
generating a second comparison video based on the decoded video; and
computing a video quality score based on the first comparison video and the second comparison video,
wherein the encoded video is selected for transmission to a client device based on the video quality score.

2. The computer-implemented method of claim 1, wherein generating the first comparison video comprises denoising the source video, generating the encoded video comprises denoising and downscaling the source video, and generating the second comparison video comprises upscaling the decoded video.

3. The computer-implemented method of claim 1, wherein generating the first comparison video comprises:
denoising the source video to generate a denoised video; and
adding first synthesized film grain to the denoised video.

4. The computer-implemented method of claim 3, wherein generating the second comparison video comprises:
adding second synthesized film grain to the decoded video to generate a renoised video; and
upscaling the renoised video to generate the second comparison video.

5. The computer-implemented method of claim 1, wherein generating the first comparison video comprises:
computing first film grain at a first resolution, wherein the encoded video has a resolution equal to the first resolution;
upscaling the first film grain to a second resolution to generate second film grain, wherein the source video has a resolution equal to the second resolution; and
adding the second film grain to a denoised version of the source video to generate the first comparison video.

6. The computer-implemented method of claim 5, wherein generating the second comparison video comprises:
adding the first film grain to the decoded video to generate a renoised video, and upscaling the renoised video to generate the second comparison video.

7. The computer-implemented method of claim 1, wherein the video quality score is computed using a video quality metric.

8. The computer-implemented method of claim 1, wherein the video quality score is computed using video multimethod assessment fusion (VMAF).

9. The computer-implemented method of claim 1, further comprising generating at least a portion of a bitrate ladder using the video quality score.

10. The computer-implemented method of claim 1, further comprising transmitting the encoded video to the client device based on the video quality score and a network bandwidth.

11. One or more non-transitory computer-readable media storing instructions that, when executed by at least one processor, cause the at least one processor to perform steps comprising:
generating a first comparison video based on a source video;
generating an encoded video based on the source video;
decoding the encoded video to generate a decoded video;
generating a second comparison video based on the decoded video; and
computing a video quality score based on the first comparison video and the second comparison video,
wherein the encoded video is selected for transmission to a client device based on the video quality score.

12. The one or more non-transitory computer-readable media of claim 11, wherein generating the first comparison video comprises denoising the source video, generating the encoded video comprises denoising and downscaling the source video, and generating the second comparison video comprises upscaling the decoded video.

13. The one or more non-transitory computer-readable media of claim 11, wherein generating the first comparison video comprises:
denoising the source video to generate a denoised video; and
adding first synthesized film grain to the denoised video.

14. The one or more non-transitory computer-readable media of claim 13, wherein generating the second comparison video comprises:
adding second synthesized film grain to the decoded video to generate a renoised video; and
upscaling the renoised video to generate the second comparison video.

15. The one or more non-transitory computer-readable media of claim 11, wherein generating the first comparison video comprises:
computing first film grain at a first resolution, wherein the encoded video has a resolution equal to the first resolution;
upscaling the first film grain to a second resolution to generate second film grain, wherein the source video has a resolution equal to the second resolution; and
adding the second film grain to a denoised version of the source video to generate the first comparison video.

16. The one or more non-transitory computer-readable media of claim 15, wherein generating the second comparison video comprises:
adding the first film grain to the decoded video to generate a renoised video, and
upscaling the renoised video to generate the second comparison video.

17. The one or more non-transitory computer-readable media of claim 11, wherein the video quality score is computed using at least one of a video multimethod assessment fusion (VMAF) or a peak signal-to-noise ratio (PSNR) technique.

18. The one or more non-transitory computer-readable media of claim 11, wherein the instructions, when executed by the at least one processor, further cause the at least one processor to perform the step of transmitting the video quality score to the client device.

19. The one or more non-transitory computer-readable media of claim 11, wherein the client device requests the encoded video based on the video quality score.

20. A system, comprising:
one or more memories storing instructions; and
one or more processors that are coupled to the one or more memories and, when executing the instructions, are configured to:
generate a first comparison video based on a source video,
generate an encoded video based on the source video,
decode the encoded video to generate a decoded video,
generate a second comparison video based on the decoded video, and
compute a video quality score based on the first comparison video and the second comparison video,
wherein the encoded video is selected for transmission to a client device based on the video quality score.
